(19) United States
(12) Patent Application Publication
(10) Pub. No.: US 2022/0329990 A1
(43) Pub. Date: Oct. 13, 2022

(54) SYSTEM AND METHOD FOR MANAGEMENT OF DRIVING MANEUVERS

(71) Applicant: AUTOTALKS Ltd., Kfar Netter (IL)

(72) Inventors: Ora Priziment, Kfar Netter (IL); Josef Blumberger, Kfar Netter (IL)

(21) Appl. No.: 17/665,698

(22) Filed: Feb. 7, 2022

Related U.S. Application Data
(60) Provisional application No. 63/172,736, filed on Apr. 9, 2021.

(51) Int. Cl. H04W 4/40; G08G 1/0967; B60K 35/00

(52) U.S. Cl. CPC H04W 4/40; G08G 1/096766; B60K 35/00; B60K 2370/166

(57) ABSTRACT

A system and method for managing driving maneuvers including: providing a requesting driving maneuver management system (DMMS) module in a requesting vehicle, and a responding DMMS module associated with a responding road user; by the requesting DMMS module, sending a request indicating an intended driving maneuver using vehicle-to-everything (V2X) communications; and by the responding DMMS module, receiving the request and providing a request notification to the associated responding road user of the request.

### CROSS REFERENCE TO RELATED APPLICATIONS

This application claims priority from U.S. Provisional Patent Application No. 63/172,736 filed on Apr. 9, 2021, which is expressly incorporated herein by reference in its entirety.

### FIELD

Embodiments disclosed herein relate generally to systems and methods for advertisement of a vehicle driver's intention to execute a driving maneuver in a traffic environment.

### BACKGROUND

There are many driving situations in which drivers need or want to execute a maneuver that potentially interferes with normal traffic flow, such as parking along a street when cars are approaching from behind; leaving a parking spot when crossing traffic is present; or taking a turn into a junction with vehicles arriving from different directions. Such maneuvers pose high risks and endanger the vehicle and road users due to a limited ability to declare the intent for performing such maneuvers in advance, especially in situations where visibility is limited.

Currently, drivers' intentions are generally communicated to the surrounding traffic environment using car lights (brake lights, reverse lights, indicator lights) or via expressions on the drivers' faces, or signals made using their voices and/or hands. These means may have very limited visibility and can thus only be seen by the drivers/pedestrians in close proximity to the indicating vehicle. Moreover, all these means may be easily missed by the relevant vehicle drivers and/or their advanced driver-assistance system (ADAS) or autonomous vehicle (AV) systems, resulting in misunderstanding of the driver intention, leading to accidents, injuries, damages, and frustration.

There is therefore a need for, and it would be advantageous to have, a system to enable indication of an intended driving maneuver, as well as acknowledgement by relevant vehicles and/or pedestrians that the driving maneuver may be performed safely.

### SUMMARY

Embodiments disclosed include systems and methods for declaring (requesting) a vehicle/driver's intention to execute a driving maneuver in a traffic “environment” that may include manned vehicles, autonomous vehicles, and pedestrians (herein referred to as “other road users”). In response, the requesting driver/vehicle may receive responses of “request granted” or “request rejected” from each of the other road users. It should be appreciated that the disclosed systems and methods may increase road safety by enabling a driver to indicate driving intentions to other road users, including those other road users that cannot directly see the driver/vehicle, and giving the other road users the potential to respond.

The system is referred to herein as a driving maneuver management system (DMMS) including DMMS modules that may be installed in vehicles and may be carried by pedestrians as well. As used herein the term “vehicle” may include but is not limited to cars, trucks, buses, motorcycles, bicycles, scooters, and so forth. A “driver” is the driver of a “vehicle” as defined herein and may include human as well as autonomous (computer controlled) driving systems. An “other road user” may be a driver, pedestrian, or autonomous vehicle that is within the environment of the requesting vehicle and may also be referred to herein as a “responding” other road user. Since the requesting driver may be a human driver or autonomous vehicle the request may be described herein as coming from the vehicle and/or driver and this should be understood to refer to both types of driver (human driver or autonomous vehicle). Since the responding other road user may be a human driver or autonomous vehicle a response may be described herein as coming from the vehicle and/or driver and this should be understood to refer to both types of other road users (human driver or autonomous vehicle).

The DMMS module may include a V2X (vehicle to everything) wireless communication module, a human machine interface (HMI) to input the intended driving maneuver and to present granted/rejected information, and a processing module for collecting and processing the requests and the responses received from the environment. The intended driving maneuvers may include but are not limited to entering a parking space, leaving a parking space, crossing road intersections, and lane merging/departure/entering including sharp lane merges from a parked position. In some embodiments, notification of leaving a parking space may be provided to drivers looking for parking spaces.

In some embodiments, the intended driving maneuvers may be indicated to the HMI by voice (driver vocally stating an intention) or using other interface means such as a touch screen, button, an assigned lever, or similar. In some embodiments, the intended driving maneuver may be automatically identified by the DMMS module using data received from vehicle sensors and/or from an ADAS. In some embodiments, the intended driving maneuver is presented only to other road users for which the information is relevant. Relevant other road users may include those in the vicinity of the requesting vehicle, and/or those that may be affected by the intended driving maneuver, even (or especially) where the other road users may not be able to see the requesting vehicle. In some embodiments, the relevancy of the message is determined by the requesting DMMS module, while in other cases it may be determined by the responding vehicle DMMS/module. In some embodiments, a “request granted”/“request rejected” response is provided only by the each of the relevant vehicles and/or pedestrians. In some embodiments, responding vehicles and/or pedestrians may use an HMI that is voice based or uses other interface means. In some embodiments, a response may be automatically generated by the DMMS module based on vehicle data received from vehicle sensors, an ADAS or an autonomous vehicle control system.

In some embodiments, once the responses from all relevant other road users are received and processed, they may be presented to the requesting driver (human or autonomous). Once a “request granted” response is determined from the one or more responses, the driver/vehicle requesting the intended driving maneuver may proceed with the intended driving maneuver. The final decision on execution of the maneuver may be with the driver since there may be road users that don't have a DMMS module and that didn't respond to the request but are using the road in a way that may pose risk to performing the intended driving maneuver.

In some embodiments, the response is provided such that any required safety distance and/or time are taken into account by the responding DMMS module for performing the intended maneuver.

In some embodiments, a method for managing driving maneuvers includes: providing a requesting driving maneuver management system (DMMS) module in a requesting vehicle, and a responding DMMS module associated with a responding road user; by the requesting DMMS module, sending a request indicating an intended driving maneuver using vehicle-to-everything (V2X) communications; and by the responding DMMS module, receiving the request indicating the intended driving maneuver and providing a request notification to the associated responding road user of the request. In some embodiments, alternative or supplemental communication protocols and standards are used in addition to V2X. In some embodiments, the intended driving maneuver is defined by a driver of the requesting vehicle or determined by the requesting DMMS module based on data from a vehicle subsystem.

In some embodiments, the method further includes, by the responding DMMS module, sending a response to the requesting DMMS module using V2X communications, wherein the response indicates that the request is granted or rejected. In some embodiments, the method further includes, by the requesting DMMS module, receiving the response, determining whether the response indicates that the request is granted or rejected, and providing a response notification to the driver of the requesting vehicle.

In some embodiments, when multiple responses are received from multiple responding DMMS modules, the response notification is an aggregated response and the determining whether the response indicates that the request is granted or rejected includes assigning a weighted score to each of the multiple responses. In some embodiments, each of the requesting and responding DMMS modules includes a human-machine interface (HMI) and wherein the request and response notifications are provided via the respective HMIs.

In some embodiments, an HMI is configured for one or more of inputting by a driver of an intended driving maneuver and inputting by a responding road user of a response to a received request. In some embodiments, the request includes a driving maneuver ID field that represents one or more driving maneuvers including leaving a parking space, intention to park, crossing an intersection, lane mergers at junctions or elsewhere, lane changes, passing another car, turning across an intersection, crossing an intersection, and turning into an intersection.

In some embodiments, the response includes a response type field indicating whether the request is granted or rejected.

In some embodiments, a system for managing driving maneuvers includes a requesting driving maneuver management system (DMMS) module in a requesting vehicle and a responding DMMS module associated with a responding road user, wherein the requesting DMMS is configured for sending a request indicating an intended driving maneuver using vehicle-to-everything (V2X) communications and wherein the responding DMMS module is configured for receiving the request and providing a request notification to an associated responding road user of the request. In some embodiments, the intended driving maneuver is defined by a driver of the requesting vehicle or determined by the requesting DMMS based on data from a vehicle subsystem.

In some embodiments, the responding DMMS module is configured for sending a response to the requesting DMMS module using V2X communications, wherein the response indicates that the request is granted or rejected. In some embodiments, the requesting DMMS module is configured for receiving the response, determining whether the response indicates that the request is granted or rejected, and providing a response notification to the driver of the requesting vehicle.

In some embodiments, when multiple response are received from multiple responding DMMS modules, the response notification is an aggregated response and the determining whether the response indicates that the request is granted or rejected includes assigning a weighted score to each of the multiple responses. In some embodiments, each of the requesting and responding DMMS modules includes a human-machine interface (HMI) and wherein the request and response notifications are provided via the respective HMIs. In some embodiments, an HMI is configured for one or more of inputting by a driver of an intended driving maneuver and inputting by a responding road user of a response to a received request.

In some embodiments, the response includes a response type field indicating whether the request is granted or rejected. In some embodiments, the request includes a driving maneuver ID field that represents one or more driving maneuvers including leaving a parking space, intention to park, crossing an intersection, lane mergers at junctions or elsewhere, lane changes, passing another car, turning across an intersection, crossing an intersection, and turning into an intersection.

It should be appreciated that the examples provided herein relating to right-side driving environments may also be applied to left-side driving environments with suitable modifications. Requests and responses may be described herein as generated by drivers and/or vehicles depending on whether the request/response was generated with driver input or not.

This Summary is provided to introduce a selection of concepts in a simplified form that are further described in the Detailed Description below. It may be understood that this Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings.

### BRIEF DESCRIPTION OF THE DRAWINGS

Non-limiting examples of embodiments disclosed herein are described below with reference to figures attached hereto that are listed following this paragraph. The drawings and descriptions are meant to illuminate and clarify embodiments disclosed herein and should not be considered limiting in any way. Like elements in different drawings may be indicated by like numerals. Elements in the drawings are not necessarily drawn to scale.

FIG. 1A illustrates a driving maneuver management system (DMMS) environment according to some implementations;

FIG. 1B illustrates schematically a block diagram of a DMMS module according to some implementations;

FIG. 2A illustrates a flow chart of a of a process for intended driving maneuver requests and responses in a DMMS environment according to some implementations;

FIGS. 2B-2D illustrate the process for intended driving maneuver requests and responses in varying DMMS environments according to some implementations.

### DETAILED DESCRIPTION

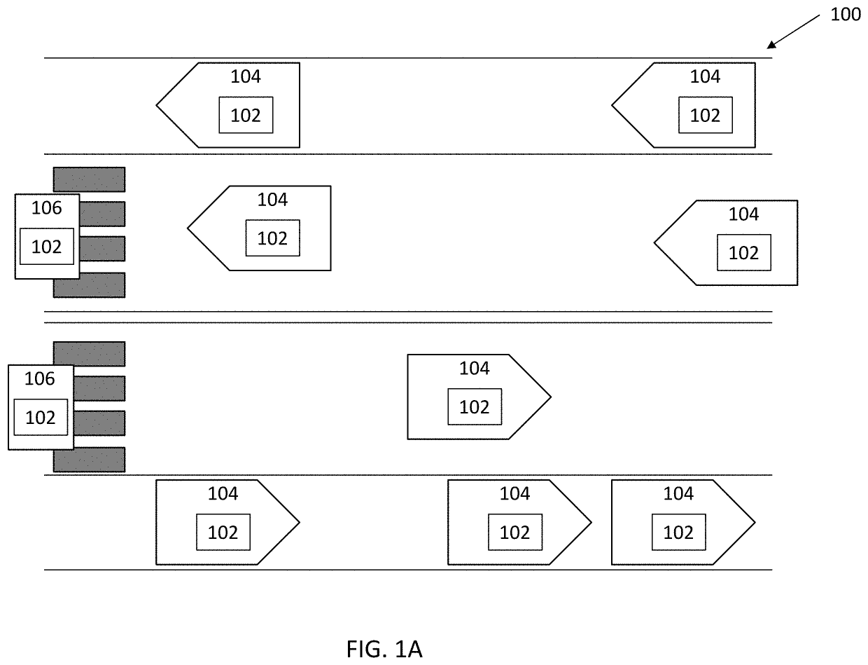

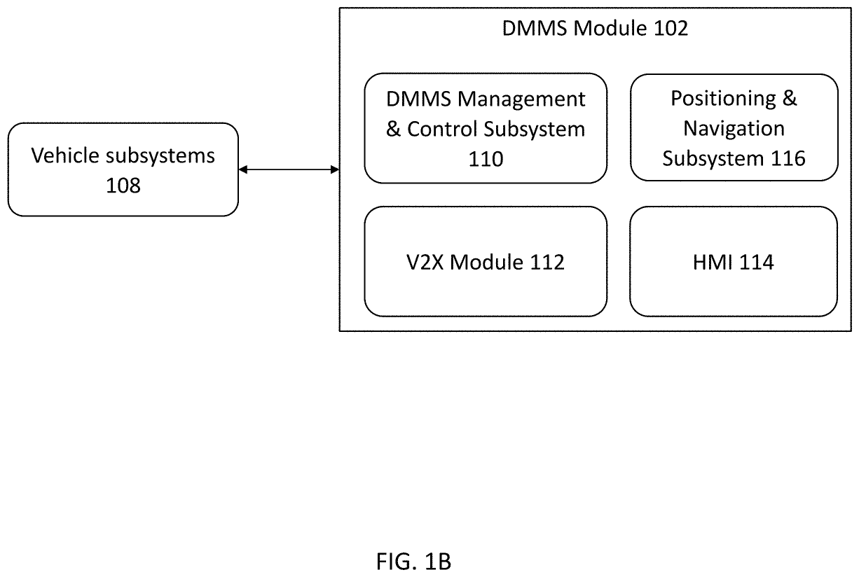

Embodiments disclosed herein provide for systems and methods for advertisement of and response to a vehicle driver's intended driving maneuvers in a traffic environment. FIG. 1A illustrates a DMMS environment 100 according to some implementations including DMMS modules 102 that may be installed in vehicles 104 (shown here are four such vehicles 104-1 to 104-4) and/or carried by pedestrians 106.

FIG. 1B illustrates schematically a block diagram of a DMMS module 102 according to some implementations. DMMS 102 is a computing device as defined herein. DMMS module 102 may interface with a vehicle 104, particularly with vehicle subsystems 108 that may include vehicle computing systems/sensors/ADAS.

DMMS 102 may include a DMMS management and control subsystem (MCS) 110. MCS 110 may manage the operation of the components of DMMS module 102 and may direct the flow of data between the components of DMMS module 102. For example, MCS 110 may provide the processing, analysis, and synthesis of the DMMS data including requests being sent to and responses coming from other road users, as well as the data presented to the user via a human-machine interface (HMI) 114. Where DMMS module 102 may be said herein to provide specific functionality or perform actions or processes, it should be understood that the functionality or actions are performed by MCS 110 that may perform the functionality or actions or may call on other components of DMMS module 102 for performing functionality or actions.

DMMS module 102 components such as hardware and software modules may include a V2X module 112, HMI 114, and a positioning & navigation subsystem 116.

V2X module 112 connects DMMS modules 102 of the vehicles 104 with other road users that are part of DMMS 100 environment using wireless V2X communication. The number of vehicles 104 and pedestrians 106 shown in FIG. 1A is illustrative and it should be appreciated that DMMS 100 may include any relevant number of vehicles 104 and pedestrians 106 having DMMS modules 102 communicating simultaneously (using V2X modules 112). It should be appreciated that, in practice, DMMS modules 102 used by pedestrians 106 may have different components and form factors than those used in vehicles 104, but for simplicity both types will be referred to herein as DMMS module 102.

V2X module 112 may transmit/receive intended driving maneuver declaration/advertisement requests (or simply “requests”) and responses. “V2X communications” as used herein refers to use of V2X standards, protocols and frequencies adapted for use in a DMMS environment 100 as described herein. V2X module 112 may include a modem (not shown), a communication stack (not shown) and means to transmit wirelessly utilizing the V2X frequency band (such as antenna, RF, TX, and RX chains, etc.). V2X module 112 may use IEEE802.11p or 3GPP C-V2X PC5 or other V2X standards for communication. The V2X communication stack may include the following dedicated request and response messages added to enable operation of DMMS 100:

Intended driving maneuver request including but not limited to the following fields: Originating Vehicle ID, Driving Maneuver ID, Driving Maneuver Type, Location, Time stamp, speed, heading;

Intended driving maneuver request granted response including but not limited to the following fields: Originating Vehicle ID, Driving Maneuver ID, Location, Time stamp, time of acknowledgement, speed, heading, Response type (“Granted”); and

Intended driving maneuver request rejected response including but not limited to the following fields: Originating Vehicle ID, Driving Maneuver ID, Location, Time stamp, speed, heading, Response type (“Rejected”).

HMI 114 may include human interface components including displays, touch surfaces, microphones, speakers, buttons, switches, levers, cameras and so forth, enabling physical and/or voice interaction with HMI 114. HMI 114 may include various options to input and output intended driving maneuvers and responses. HMI 114 may display a received and processed response from relevant other road users in the proximity of the requesting vehicle/driver, including their relative location with respect to the vehicle issuing an intended driving maneuver request. HMI 114 may enable a choice of an intended driving maneuver request such as but not limited to leaving a parking space, intention to park, crossing an intersection, lane mergers at junctions or elsewhere, lane changes, passing another car, turning across an intersection, crossing an intersection, turning into an intersection, and so forth.

MCS 110 may generate intended driving maneuver requests generate request granted/rejected responses (also referred to herein as “responses”) and manage/process received responses. In some embodiments, requests may be generated via the driver interaction with HMI 114 i.e., by the driver initiating the request. In some embodiments, a request may be generated/initiated automatically by MCS 110 following analysis of vehicle data provided by vehicle subsystems 108. Vehicle subsystems 108 may include but are not limited to cameras, LIDAR, accelerometer, gear system, GPS, ADAS, and so forth, installed on vehicle 104. In some embodiments, the following intended driving maneuvers may be automatically determined such that a request may be generated automatically: leaving a parking space, intention to park (determined, for example, based on approaching a target address), crossing an intersection, lane mergers at junctions or elsewhere, lane changes, passing another car, turning across an intersection, crossing an intersection, turning into an intersection (determined, for example, based on driver use of vehicle indicators and/or vehicle sensors and/or navigation components), and so forth.

In some embodiments, having received a request that is displayed on HMI 114 of another road user, a response (granted/rejected) may be input by the other road user via HMI 114 based, for example, on assessment of the other road user. Responses may be formed and sent by MCS 110 (via V2X module 112) following input from HMI 114.

In some embodiments, a response may be generated automatically by MCS 110 following analysis to determine the feasibility (safety) of sending a request granted response. Factors taken into account may include but are not limited to the distance, direction, heading, speed, altitude, acceleration, and so forth that may be obtained, for example, by using vehicle sensor data, and data received from the requesting vehicle (time stamp, speed, driving maneuver ID). A “request granted” response may be generated if it is determined that granting of the request granted response is possible without endangering the responding vehicle or other road users. A request rejected response may be generated if it is determined that the intended driving maneuver may endanger or inconvenience the responding vehicle or other road users.

The one or more responses are received by the requesting DMMS module 102, and the requesting MCS 110 may map relevant other road users by analyzing its own and responding vehicle locations, headings, driving maneuver IDs, time stamps and speeds. In some embodiments, the responses of relevant road users are processed and combined into a map of the requesting vehicle's traffic environment that may be presented on HMI 114 to the requesting vehicle's driver such that the driver may assess the situation before execution of the maneuver. Based on the received “request granted” responses and if no “request rejected” response was received from relevant other road users, the intended driving maneuver may be executed at the discretion of the driver receiving the processed response summary.

Positioning and navigation subsystem 116 may provide time, position, and navigation (speed, heading, acceleration, altitude) data to MCS 110, in order to enable creation of the traffic environment map. The traffic environment map may be based on a known map of the area the vehicle is in, with available driving paths, and/or the location, direction and speed of other road users that may be relevant to the requesting vehicle's driving conditions. Positioning and navigation subsystem 116 may provide position and navigation data to MCS 110 to further enable generation of responses to drivers that have sent requests including the responding vehicle information, such as position, heading, speed and other relevant information.

The interface (not shown) between DMMS 110 and vehicle subsystems 108 may provide for receiving vehicle data as well as transmitting determined responses (granted/rejected).

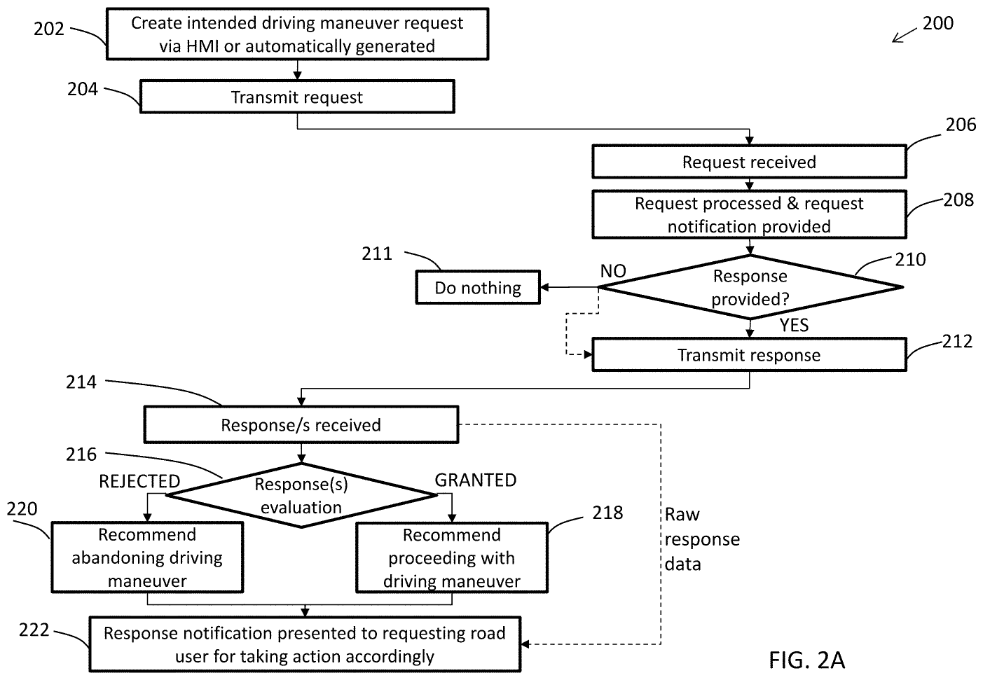

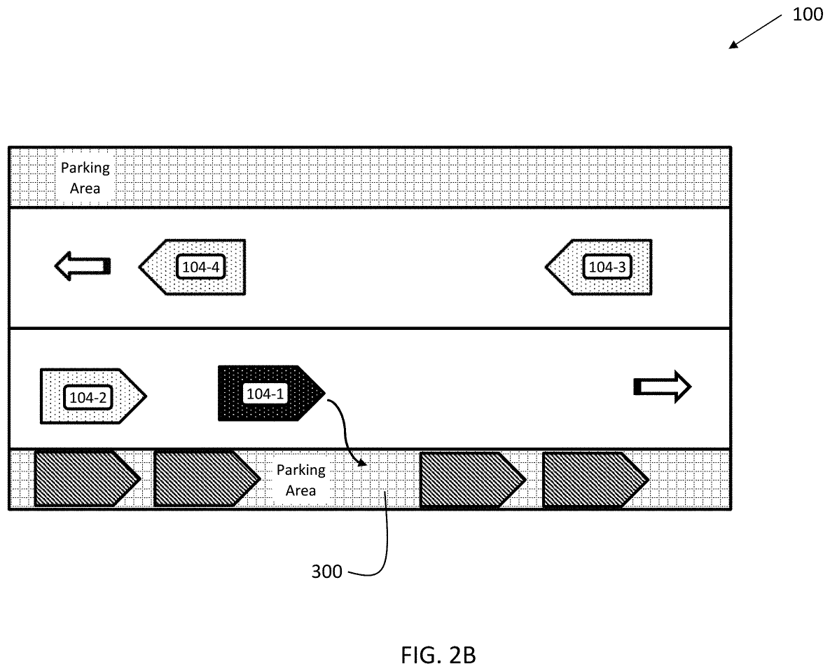

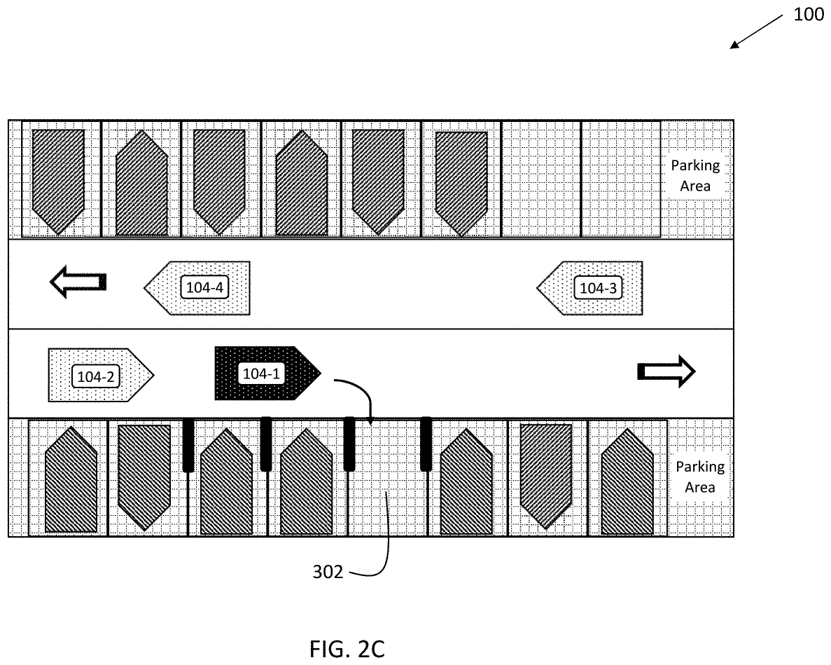

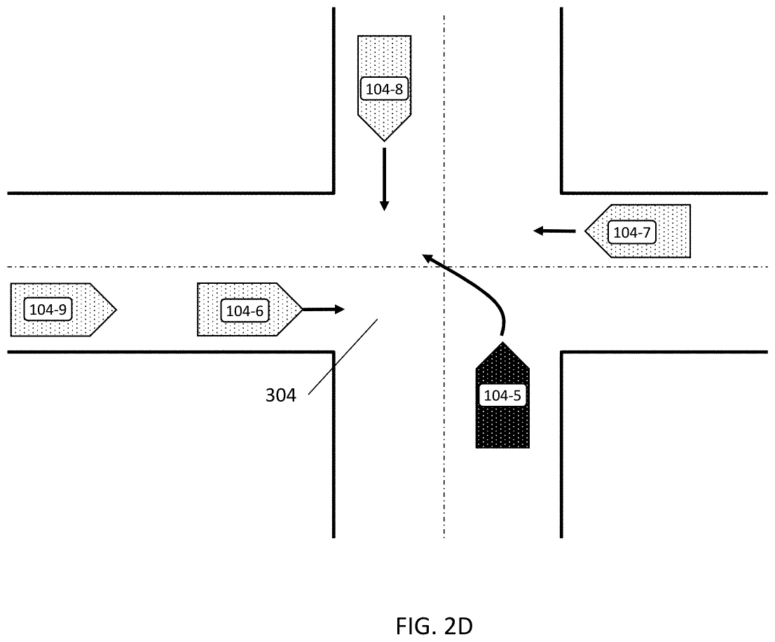

FIG. 2A illustrates a flow chart of a process 200 for intended driving maneuver requests and responses in a DMMS environment according to some implementations. FIGS. 2B-2D illustrate process 200 in varying DMMS environments according to some implementations. Process 200 may be performed by DMMS modules (such as DMMS module 102 described above) installed or otherwise associated with road users in a DMMS environment 100. The steps below are described with reference to one or more computing devices that perform operations described at each step. The computing devices can correspond to a DMMS module 102. Where process 200 refers to operation of a DMMS module, this should be understood as referring to operation of the components of DMMS module 102 that may be controlled by MCS 110. In the description of process 200, the vehicle that may perform the intended driving maneuver is referred to as the “requesting vehicle” and other road users that may respond to the request are referred to as “responding road users”.

In step 202, a driver of a requesting vehicle that is intending to perform a driving maneuver with the requesting vehicle may interact with an HMI in the requesting vehicle to indicate the intended driving maneuver. Following interaction with the HMI, an intended driving maneuver request may be created by the requesting DMMS module of the requesting vehicle. Alternatively, an intended driving maneuver request may be generated/initiated automatically by the requesting DMMS module following analysis of vehicle data provided by vehicle subsystems of the requesting vehicle. In step 204, the intended driving maneuver request is transmitted wirelessly by the requesting DMMS module, such as by a V2X module.

In step 206, the request is received by other road users having other road user DMMS modules in the vicinity of the requesting vehicle, for example, up to a few kilometers away. Depending on the traffic environment, the vicinity may be, for example, up to 500 m from the requesting vehicle.

In step 208, the request is processed by the receiving DMMS module and the other road user may be notified (herein a “request notification”) of the request via the HMI of receiving DMMS module. In some embodiments, the request notification may be via an on-screen display of the HMI. In some embodiments, the request notification may be an audible alarm.

In step 210, the other road user may respond to the request via the HMI of the other road user DMMS module such as by pressing a button, interacting with a touch screen and/or issuing a voice command to indicate that the request is granted or rejected. In some embodiments, where the other road user is an autonomous vehicle, the vehicle may respond to the request by interacting directly with the other road user DMMS module (such as through the interface to vehicle subsystems 108). The response type field may be “granted” or “rejected” depending on whether the other road user determines, for example, that the requested intended driving maneuver can be performed safely. In some embodiments, the determination of the response type is made by the responding DMMS module. In some embodiments, the determination of the response type is made by an autonomous vehicle interacting with the responding DMMS module. Alternatively, at step 210, the other road user may not respond, either by choice or due to not receiving or paying attention to the request notification or due to not having a DMMS module. In such a case of no response, the associated DMMS module may take no action (step 211). Alternatively, in some embodiments, in such a case of no response, the associated DMMS module will generate a request rejected response (step 212).

In step 212, the response is wirelessly transmitted by the other road user DMMS module, such as via the V2X module. In step 214, the response (or responses from multiple other road users) is received by the requesting DMMS module. Upon receipt of the response, in step 216, the requesting DMMS module may determine whether the response type is granted or rejected. In some embodiments, where one response is received, the requesting DMMS may make the determination based on the response type field (granted/rejected) included in the response. In some embodiments, where multiple responses are received, the determined response may be an aggregated response. To determine an aggregated response, each response may be assigned a weighted score depending on the response type (granted/rejected) and optionally other factors (such as the potential risk of the requested maneuver). The weighted scores may be aggregated to determine the aggregated response. In some embodiments, rejected responses carry a greater weight in the determination of the aggregated response in order to reject potentially unsafe driving maneuvers.

In some embodiments, the requesting DMMS module may provide a recommendation and/or risk score to the driver based on the determined aggregated response of granted (step 218) or rejected (step 220).

In step 222, the requesting driver may be provided with a “response notification” via the HMI of the requesting DMMS module (such as for a human driver). In some embodiments, the response notification may be provided by the requesting DMMS module to the vehicle subsystems (such as for an autonomous vehicle).

The response notification may take various forms: in some embodiments, the response notification may include a list of responding other road users along with the response received from each other road user (raw response data received in step 214); in some embodiments, the response notification may include a map of the other road users indicating the granting and rejecting road users; in some embodiments, the response notification may include the determined aggregated response; in some embodiments, the response notification may include a recommendation and/or risk score; and in some embodiments, the response notification may include a combination of the above notification types, for example a map of responding other road users along with a recommendation and risk score.

The requesting driver/vehicle reaction to the response will differ depending on the response notification presented in step 222. In some embodiments, where the requesting vehicle is an autonomous vehicle, the driving maneuver may proceed (steps 218, 222) if the request was granted. In some embodiments, where the requesting vehicle is an autonomous vehicle, the driving maneuver may be abandoned (steps 220, 222) if the request was rejected. Alternatively, if the notification type was raw response data received at step 214, the autonomous vehicle may determine whether to proceed with or abandon the driving maneuver based on the raw response data. Alternatively, if the notification type was raw response data combined with an aggregated response and/or a recommendation and/or a risk score, the autonomous vehicle may determine whether to proceed with or abandon the driving maneuver based on a combination of the provided data.

A driver may assess the response notification of step 222 and, for example, make the decision to proceed (following steps 218, 222) or abandon (following steps 220, 222) the driving maneuver. In some embodiments, the response notification may be via the HMI of the requesting DMMS module, such as an on-screen display (for example “parking request granted”). In some embodiments, the notification may be an audible alarm. In some embodiments, a low-risk notification may result in the driver proceeding with the driving maneuver. In some embodiments, the HMI may present a recommendation as a colored scale.

The responding other road user may also take appropriate actions for ensuring safe completion by the requesting vehicle of the driving maneuver, for example by using the responding vehicle's ADAS/AV systems, such as braking, keeping a distance, slowing down, and so forth.

“No response data” may be formed by the DMMS module of the requesting user where other road users have been identified by the DMMS module (such as by transmissions from CV2X or ADAS systems present in the other road users), but where no response to a transmitted request has been received from these other road users. The DMMS module of the requesting user may include this no-response data in determining one or more of an aggregated response, a recommendation, and/or a risk score. Further, this no-response data may be included in the response notification. For example, a response notification may include a map of responding and non-responding other road users along with a recommendation and risk score influenced by the no-response data.

It should be appreciated that the DMMS system may be considered a “decision supporting” system. Other road users with DMMS modules in the vicinity of the “maneuvering” car get notified and warned, and the requesting vehicle/driver gets a better understanding of the surrounding dangers, as an additional input before proceeding with the driving maneuver. The requesting driver may make the final decision to proceed or not. Alternatively, an autonomous vehicle may make the decision to proceed or not, based on the received responses and risk-assessment logic of the autonomous vehicle.

Non-limiting examples are provided below to illustrate process 200.

### Example 1

As shown in FIGS. 2B and 2C, vehicle 104-1 equipped with a DMMS module is arriving at an intended destination and is looking for an available parking spot. In step 202, the driver in vehicle 104-1 initiates a “looking for parking” request. Alternatively, the request is generated automatically by the requesting DMMS following analysis of data from vehicle subsystems (reaching destination, slowing down, etc.).

In step 204, the request is broadcast using V2X communications to nearby other road users 104-2, 104-3, and 104-4 that all have DMMS modules. In steps 206 and 208, the other road users 104-2, 104-3, and 104-4 receive a notification of the intended driving maneuver of vehicle 104-1.

In step 210, other road users 104-2, 104-3, and 104-4 each initiate “granted” or “rejected” responses that are transmitted (step 212) and received by vehicle 104-1 (step 214). Alternatively, one or more of other road users 104-2, 104-3, and 104-4 fail to respond.

Having determined, in step 216, that the driving maneuver is granted, a response notification for a granted maneuver is presented to the driver of vehicle 104-1 in step 222. The driver of vehicle 104-1 may then perform the maneuver by slowing to enter parking 300 (FIG. 2B) or 302 (FIG. 2C). The other road users 104-2 and 104-3 (behind and opposite the requesting vehicle 104-1) may slow down or stop completely, enabling the parking vehicle 104-1 to complete a parking maneuver.

Alternatively, when a “rejected” response is determined and presented in the response notification (step 222), the requesting driver may decide to stop the maneuver and wait for a better opportunity to complete such a maneuver at a later stage, once the rejecting vehicle/s have moved on.

Alternatively, one or more of other road users 104-2, 104-3, and 104-4 do not respond and this no-response data is included in the determined response notification of step 222. Vehicle 104-1 may proceed in step 222 by slowing to enter parking 300 (or 302) but the driver is made aware via the response notification that other road users in the vicinity may not be aware of the intended driving maneuver and therefore the driver may proceed with greater caution. Alternatively, the driver may decide to abandon the maneuver as the non-responsive drivers make it too dangerous. Also in step 222, other road users that have seen the request (even without responding) may slow down or stop, enabling the parking vehicle 104-1 to complete a parking maneuver.

### Example 2

As shown in FIG. 2D, vehicle 104-5 that is equipped with a DMMS module intends to turn across intersection 304. In step 202, the driver in vehicle 104-5 initiates a “lane merger in junction” request. Alternatively, the request is generated automatically by the requesting DMMS following analysis of data from vehicle subsystems.

In step 204, the request is broadcast using V2X communications to nearby other road users 104-6, 104-7, 104-8, and 104-9 that all have DMMS modules. In step 208, the other road users 104-6, 104-7, 104-8, and 104-9 receive a notification of the intended driving maneuver of vehicle 104-5. It should be appreciated that vehicle 104-9 does not have line of sight to the turning vehicle 104-5, illustrating the value of the presently described system and method.

In step 210, other road users 104-6, 104-7, 104-8 and 104-9 each initiate “granted” or “rejected” responses that are transmitted (step 212) and received by vehicle 104-5 (step 214). Alternatively, one or more of other road users 104-6, 104-7, 104-8 and 104-9 fail to respond.

Having determined, in step 216, that the driving maneuver is granted, a response notification for a granted maneuver is presented to the driver of vehicle 104-5 in step 222. Vehicle 104-5 may proceed to cross the intersection 304. Other road users 104-6, 104-7, 104-8 and 104-9 slow down or stop completely if required, enabling the crossing vehicle 104-5 to complete the turn maneuver.

Alternatively, when a “rejected” response is determined (step 220) and presented in the response notification (step 222), the requesting driver may decide to stop the maneuver and wait for a better opportunity to complete such a maneuver at a later stage, once the rejecting vehicle/s have moved on.

Alternatively, one or more of other road users 104-6, 104-7, 104-8 and 104-9 do not respond and the related no-response data is included in the determination of the response notification of step 222. Vehicle 104-5 proceeds in step 220 by more cautiously crossing intersection 304 since the driver made aware by the response notification that other road users in the vicinity may not be aware of the intended driving maneuver. Also in step 222, other road users that have seen the request (even without responding) regard it as a warning and slow down, enabling the turning vehicle 104-5 to complete the turn.

Unless otherwise defined, all technical and scientific terms used herein have the same meaning as commonly understood by one of ordinary skill in the art. The materials, methods, and examples provided herein are illustrative only and not intended to be limiting.

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware (HW) or by software (SW) on any operating system of any firmware, or by a combination thereof. For example, as hardware, selected steps of the disclosure could be implemented as a processor chip or a circuit. As software or algorithm, selected steps of the disclosure could be implemented as a plurality of software instructions being executed by a computer/processor using any suitable operating system. In any case, selected steps of the method and system of the disclosure could be described as being performed by a data processor, such as a computing device for executing a plurality of instructions.

Various implementations of the systems and techniques described here can be realized in digital electronic circuitry, integrated circuitry, specially designed ASIC s (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Although the present disclosure is described with regard to a “computing device”, a “computer”, or “mobile device”, it should be noted that optionally any device featuring a data processor and the ability to execute one or more instructions may be described as a computing device, including but not limited to any type of personal computer (PC), a server, a distributed server, a virtual server, a cloud computing platform, a cellular telephone, an IP telephone, a smartphone, a smart watch or a PDA (personal digital assistant). Any two or more of such devices in communication with each other may optionally comprise a “network” or a “computer network”.

To provide for interaction with a user, the systems and techniques described here can be implemented on a computing device having a display (indicator/monitor/screen/array) (such as a LED (light-emitting diode), OLED (organic LED), LCD (liquid crystal display) or other display technology) for displaying information to the user and a keyboard and a pointing device (e.g., a mouse, joystick or a trackball) or individual buttons/knobs/levers (such as driving wheel buttons/signaling levers) by which the user can provide input to the computing device. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, analysis of user head position and/or eye movements, or tactile input.

It should be appreciated that the above-described methods and apparatus may be varied in many ways, including omitting, or adding steps, changing the order of steps and the type of devices used. It should be appreciated that different features may be combined in different ways. In particular, not all the features shown above in a particular embodiment or implementation are necessary in every embodiment or implementation of the disclosure. Further combinations of the above features and implementations are also considered to be within the scope of some embodiments or implementations of the disclosure.

While certain features of the described implementations have been illustrated as described herein, many modifications, substitutions, changes, and equivalents will now occur to those skilled in the art. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations and embodiments described.

What is claimed is:

1. A method for managing driving maneuvers, comprising:
providing a requesting driving maneuver management system (DMMS) module in a requesting vehicle, and a responding DMMS module associated with a responding road user;
by the requesting DMMS module, sending a request indicating an intended driving maneuver using vehicle-to-everything (V2X) communications; and
by the responding DMMS module, receiving the request indicating the intended driving maneuver and providing a request notification to the associated responding road user of the request.

2. The method of claim 1, wherein the request includes a driving maneuver ID field that represents one or more driving maneuvers including leaving a parking space, intention to park, crossing an intersection, lane mergers at junctions or elsewhere, lane changes, passing another car, turning across an intersection, crossing an intersection, and turning into an intersection.

3. The method of claim 1, wherein the intended driving maneuver is defined by a driver of the requesting vehicle or determined by the requesting DMMS module based on data from a vehicle subsystem.

4. The method of claim 3, further comprising, by the responding DMMS module, sending a response to the requesting DMMS module using V2X communications, wherein the response indicates that the request is granted or rejected.

5. The method of claim 4, wherein the response includes a response type field indicating whether the request is granted or rejected.

6. The method of claim 4, further comprising, by the requesting DMMS module, receiving the response, determining whether the response indicates that the request is granted or rejected, and providing a response notification to the driver of the requesting vehicle.

7. The method of claim 6, wherein when multiple responses are received from multiple responding DMMS modules, the response notification is an aggregated response and the determining whether the response indicates that the request is granted or rejected includes assigning a weighted score to each of the multiple responses.

8. The method of claim 6, wherein each of the requesting and responding DMMS modules includes a human-machine interface (HMI) and wherein the request and response notifications are provided via the respective HMIs.

9. The method of claim 8, wherein an HMI is configured for one or more of inputting by a driver of an intended driving maneuver and inputting by a responding road user of a response to a received request.

10. A system for managing driving maneuvers comprising a requesting driving maneuver management system (DMMS) module in a requesting vehicle and a responding DMMS module associated with a responding road user, wherein the requesting DMMS is configured for sending a request indicating an intended driving maneuver using vehicle-to-everything (V2X) communications and wherein the responding DMMS module is configured for receiving the request and providing a request notification to an associated responding road user of the request.

11. The system of claim 10, wherein the intended driving maneuver is defined by a driver of the requesting vehicle or determined by the requesting DMMS based on data from a vehicle subsystem.

12. The system of claim 10, wherein the responding DMMS module is configured for sending a response to the requesting DMMS module using V2X communications, wherein the response indicates that the request is granted or rejected.

13. The system of claim 11, wherein the request includes a driving maneuver ID field that represents one or more driving maneuvers including leaving a parking space, intention to park, crossing an intersection, lane mergers at junctions or elsewhere, lane changes, passing another car, turning across an intersection, crossing an intersection, and turning into an intersection.

14. The system of claim 12, wherein the requesting DMMS module is configured for receiving the response, determining whether the response indicates that the request is granted or rejected, and providing a response notification to the driver of the requesting vehicle.

15. The system of claim 12, wherein the response includes a response type field indicating whether the request is granted or rejected.

16. The system of claim 14, wherein when multiple responses are received from multiple responding DMMS modules, the response notification is an aggregated response and the determining whether the response indicates that the request is granted or rejected includes assigning a weighted score to each of the multiple responses.

17. The system of claim 14, wherein each of the requesting and responding DMMS modules includes a human-machine interface (HMI) and wherein the request and response notifications are provided via the respective HMIs.

18. The system of claim 17, wherein an HMI is configured for one or more of inputting by a driver of an intended driving maneuver and inputting by a responding road user of a response to a received request.
